(19) United States
(12) Patent Application Publication
(10) Pub. No.: US 2025/0167202 A1
(43) Pub. Date: May 22, 2025

(54) ELECTRODE FOR SECONDARY BATTERY AND METHOD OF MANUFACTURING THE SAME

(71) Applicant: SAMSUNG SDI CO., LTD., Yongin-si (KR)

(72) Inventors: Dahyun KIM, Yongin-si (KR); Bumrae KIM, Yongin-si (KR); Byonggon LEE, Yongin-si (KR)

(21) Appl. No.: 18/641,251

(22) Filed: Apr. 19, 2024

(30) Foreign Application Priority Data
Nov. 20, 2023 (KR) 10-2023-0161468

(51) Int. Cl. H01M 4/13; H01M 4/04; H01M 4/139; H01M 4/36; H01M 4/70

(52) U.S. Cl. CPC H01M 4/13; H01M 4/0404; H01M 4/139; H01M 4/366; H01M 4/70

(57) ABSTRACT

An electrode for a secondary battery includes a substrate, an active material layer including a lower layer on the substrate, and an upper layer on the lower layer, wherein an edge of the lower layer has an inclined surface having a thickness that decreases toward an end of the lower layer, and wherein the upper layer has a cut surface on the inclined surface and at an end of the upper layer, and an angle defined between the cut surface and an upper surface of the substrate is larger than an angle defined between the inclined surface and the upper surface of the substrate.

### CROSS-REFERENCE TO RELATED APPLICATION

The present application claims priority to and the benefit of Korean Patent Application No. 10-2023-0161468, filed on Nov. 20, 2023, in the Korean Intellectual Property Office, the entire content of which is incorporated herein by reference.

### BACKGROUND

### 1. Field

Embodiments of the present disclosure relate to an electrode for a secondary battery and a method of manufacturing the same.

### 2. Description of the Related Art

A secondary battery (e.g., a rechargeable battery) refers to a battery that is capable of being repeatedly charged and discharged, unlike a primary battery. A small-capacity secondary battery may be utilized for portable small-scale electronic devices, such as mobile phones, notebook computers, and/or camcorders. Relatively high-capacity, relatively high-density secondary batteries may be utilized as energy storages, e.g., energy storage units and/or power walls, and/or power sources, e.g., for operating motors of hybrid vehicles and/or electric vehicles.

The secondary battery may be manufactured by sealing an electrode assembly and an electrolyte in a casing. The electrode assembly has a structure in which positive electrodes, separators, and negative electrodes are stacked.

A jelly-roll-type or kind electrode assembly may be manufactured by forming (or providing) active material layers of the positive and negative electrodes by continuously applying active materials onto substrates provided in the form of long bands, and then winding the substrates. Alternatively, a stack-type or kind electrode assembly may be manufactured by stacking sheet-type or kind electrodes cut into set or predetermined lengths.

The active material layers may be formed (provided) on two opposite surfaces (sides) of the substrate in order to increase the capacity of the secondary battery. However, the active material layers formed (provided) on front and rear (top or bottom) surfaces of the substrate may have different in thicknesses from each other, and a greater thickness difference may occur at an edge (e.g., left or right edge) of the substrate. For this reason, a problem of lithium precipitation degrading the characteristics of the secondary battery may occur.

The above information disclosed in this Background section is only for enhancement of understanding of the background of the disclosure and therefore it may contain information that does not constitute prior art.

### SUMMARY

Aspects of one or more embodiments of the present disclosure relates to an electrode for a secondary battery having a substantially uniform thickness without causing a thickness difference at the time of forming (or providing) active material layers on two opposite surfaces (sides) of a substrate, and a method of manufacturing the same.

Additional aspects will be set forth in part in the description which follows and, in part, will be apparent from the description, or may be learned by practice of the presented embodiments of the disclosure.

An electrode for a secondary battery according to one or more embodiments of the present disclosure includes a substrate, an active material layer including a lower layer on the substrate, and an upper layer on the lower layer, in which an edge (e.g., left or right edge in a cross-sectional view) of the lower layer has an inclined surface having a thickness that decreases toward an end (e.g., left or right edge end in a cross-sectional view) of the lower layer, and in which the upper layer has a cut surface on the inclined surface and at an end of the upper layer, and an angle defined between the cut surface and an upper surface of the substrate is larger than an angle defined between the inclined surface and the upper surface of the substrate.

In one or more embodiments, a bonding force between the upper layer and the lower layer may be lower than a bonding force between the lower layer and the substrate.

In one or more embodiments, the substrate may further include a groove formed concavely from (e.g., a concave groove in) a surface of the substrate, the end of the lower layer may be in the groove, and the groove may be filled with the lower layer.

In one or more embodiments, a depth of the groove may be about 1 micrometer (μm) to about 5 μm, and a width of the groove may be about 1 millimeter (mm) to about 10 mm.

In one or more embodiments, the upper layer may cover the edge of the lower layer, such that the end of the lower layer is not exposed at (to) the cut surface.

In one or more embodiments, the end of the upper layer and the end of the lower layer may be exposed at (to) the cut surface.

In one or more embodiments, a length of the inclined surface of the lower layer may be about 30 mm from the end of the lower layer.

A method of manufacturing an electrode for a secondary battery according to one or more embodiments of the present disclosure includes: applying a lower layer onto a substrate; forming an upper layer to cover an edge of the lower layer on the lower layer; attaching a tape onto an edge of the upper layer; and removing the edge of the upper layer together with the tape.

The tape may be attached at the edge of the upper layer at a position outward of the lower layer.

In one or more embodiments, a width of the edge of the upper layer may be about 30 mm of less (e.g., 15 mm or less).

In one or more embodiments, a bonding force between the tape and the upper layer may be higher than a bonding force between the upper layer and the substrate, lower than a bonding force between the lower layer and the substrate, and lower than a bonding force between the upper layer and the lower layer.

In one or more embodiments, the attaching of the tape may include bringing the tape into close contact with an upper surface of the upper layer by pressing the tape.

In one or more embodiments, the tape may be a kraft tape or polyethylene (PE) foam.

According to one or more embodiments of the present disclosure, the edge of the active material layer may be easily arranged by utilizing the tape, thereby providing the electrode having the active material layer with a substantially uniform thickness without a difference in thickness between the edge and the central portion of the active material layer.

Therefore, it is possible to provide a substantially safe secondary battery that may not cause or may reduce a phenomenon such as lithium precipitation.

### BRIEF DESCRIPTION OF THE DRAWINGS

FIG. 1 is a schematic cross-sectional view of a negative electrode according to one or more embodiments of the present disclosure.

FIGS. 2 and 3 are each a schematic cross-sectional view of a negative electrode according to one or more embodiments of the present disclosure.

FIG. 4 is a schematic view for explaining a method of manufacturing a negative electrode according to one or more embodiments of the present disclosure.

FIG. 5 is a plan view of the negative electrode in an intermediate step (e.g., act or task) of manufacturing the negative electrode according to one or more embodiments of the present disclosure.

FIGS. 6 and 7 are each a schematic cross-sectional view taken along the line V-V′ of FIG. 5 in the intermediate step (e.g., act or task) of manufacturing the negative electrode according to one or more embodiments of the present disclosure.

FIG. 8 is a schematic perspective view of a secondary battery according to one or more embodiments of the present disclosure.

FIG. 9 is a schematic cross-sectional view taken along the line IX-IX′ of FIG. 8, according to one or more embodiments of the present disclosure.

FIG. 10 is a schematic exploded perspective view of an electrode assembly according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Hereinafter, embodiments of the present disclosure will be described in more detail with reference to the accompanying drawings so that those with ordinary skill in the art to which the present disclosure pertains may carry out the embodiments. However, the present disclosure may be implemented in various different ways and the present disclosure is not limited to one or more embodiments described herein. Rather, the embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

In the drawings, a part not relevant to a clear description of the embodiments in the present disclosure may not be provided. Unless otherwise noted, the same or similar constituent elements (or reference numerals) will be designated by the same reference numerals throughout the specification, and thus, duplicative descriptions thereof may not be provided. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “on,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, such as an area, layer, film, region, or portion, is referred to as being “on,” “connected to,” or “coupled to” another element, it can be directly on, connected to, or coupled to the other element, or one or more intervening elements may be present. In addition, it will also be understood that when an element is referred to as being “between” two elements, it can be the only element between the two elements, or one or more intervening elements may also be present.

As used herein, the singular forms “a,” “an” and “the” are intended to include the plural forms as well, unless the context clearly indicates otherwise.

It will be further understood that the terms “comprises,” “comprising,” “includes,” “including,” “have,” and “having,” when used in this specification, specify the presence of the stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items.

Unless otherwise apparent from the disclosure, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

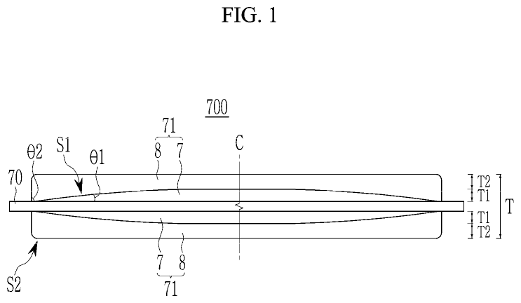

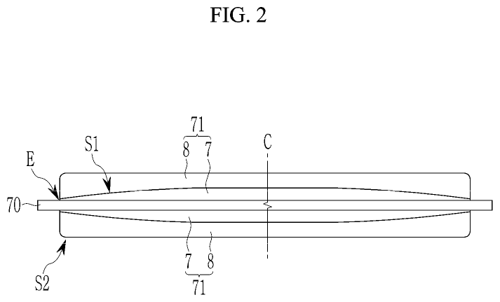

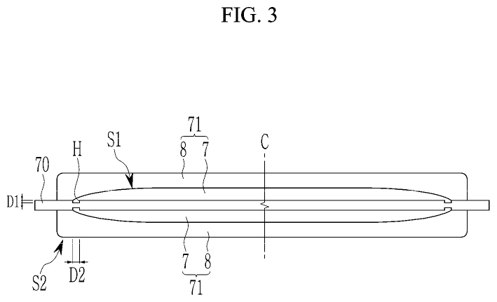

FIG. 1 is a schematic cross-sectional view of a negative electrode according to one or more embodiments of the present disclosure, and FIGS. 2 and 3 are each a schematic cross-sectional view of negative electrodes according to one or more embodiments of the present disclosure.

As illustrated in FIG. 1, an electrode 700 according to one or more embodiments of the present disclosure includes a substrate 70, and an active material layer 71 formed (provided) on one surface or two opposite surfaces of the substrate 70.

The active material layer 71 includes a lower layer 7 and an upper layer 8. The lower layer 7 is a layer formed to be in contact with the substrate 70, and the upper layer 8 is a layer positioned on the lower layer 7.

An end of the lower layer 7 has an inclined surface S1 inclined with respect to the substrate, and the upper layer 8 has a cut surface S2 that covers the inclined surface S1. The cut surface S2 may have an angle θ2 larger than an angle θ1 defined between one surface of the substrate 70 and the inclined surface S1. An angle θ2 defined between the cut surface S2 and one surface of the substrate 70 may be equal to or less than 90 degrees.

As illustrated in FIG. 1, the upper layer 8 may cover an end of the inclined surface S1. However, as illustrated in FIG. 2, a cross-section E of the lower layer 7 may be partially exposed at the cut surface S2 in accordance with a process of forming (or providing) the cut surface S2 of the upper layer 8 to be described in more detail below.

A thickness T2 of the upper layer 8 may be 30% to 50% of a thickness T of the active material layer 71 formed on one surface of the substrate, and the thickness T1 of the lower layer 7 may be 50% to 70% of the thickness T of the active material layer 71.

The active material layers, which constitute the upper and lower layers 8 and 7, may be different from each other, and bonding forces of the active material layers may be different from each other. The bonding force may be adjusted in accordance with a content (e.g., amount) of a binder to be described in more detail below. In one or more embodiments, the bonding force of the lower layer 7 may be higher than the bonding force of the upper layer 8. In one or more embodiments, the bonding force between the upper layer 8 and the lower layer 7 may be 1.5 gf/mm, and the bonding force between the lower layer 7 and the substrate 70 may be 2.0 gf/mm or more.

In one or more embodiments, as illustrated in FIG. 3, a groove H may be formed in the substrate 70, and an edge end of the lower layer 7 may be positioned in the groove H. A depth D1 of the groove H may be about 1 μm to about 5 μm, and a width D2 of the groove H may be about 1 mm to about 10 mm.

A thickness of the edge of the lower layer 7 may decrease toward the end of the lower layer 7. However, in one or more embodiments of the present disclosure, the groove H may be formed, and the end of the lower layer 7 is positioned in the groove H, such that the groove H may be filled with the end of the lower layer 7, thereby increasing the thickness of the edge of the lower layer 7.

A binder content (e.g., amount) of the upper layer 8 may be smaller than that of the lower layer 7, and the upper layer 8 has a larger thickness than the lower layer 7 at the edge of the active material layer 71. Therefore, in the entire active material layer, the binder content (e.g., amount) at the edge of the active material layer 71 may be smaller than the amount of binder at a central portion C of the active material layer 71. However, in one or more embodiments of the present disclosure, the thickness at the edge of the lower layer 7 increases as the groove H is formed in the substrate 70, such that the binder content (e.g., amount) at the edge may be almost equal to the binder content (e.g., amount) at the central portion.

With reference back to FIG. 1, the negative electrode active material included in the active material layer 71 may be a carbon-based active material. The carbon-based negative electrode active material may be made of artificial graphite and/or a (e.g., any suitable) mixture of artificial graphite and natural graphite. In embodiments in which a crystalline carbon-based material, which is made of artificial graphite and/or a (e.g., any suitable) mixture of artificial graphite and natural graphite, is utilized as the negative electrode active material, the crystallographic characteristics of particles may be improved over those of an amorphous carbon-based active material, thereby improving an orientation property of the carbon material in an electrode plate for an external magnetic field. A form of artificial graphite or natural graphite may be amorphous, plate-like, flake, spherical, fibrous, and/or a (e.g., any suitable) combination thereof, and may be in any form. In one or more embodiments, in embodiments in which the artificial graphite and the natural graphite are mixed and utilized, the (weight %) mixture ratio may be 70:30 to 95:5 (weight % (wt %)) (e.g., 7:3 to 19:1).

In one or more embodiments, the negative electrode active material layer may further include at least one of a Si-based negative electrode active material, a Sn-based negative electrode active material, or a LiMOₓ (M=metal)-based negative electrode active material. In embodiments in which the negative electrode active material layer further includes the aforementioned negative electrode active material, i.e., includes the carbon-based negative electrode active material as a first negative electrode active material and the negative electrode active material (e.g., includes at least one of a Si-based negative electrode active material, a Sn-based negative electrode active material, or a LiMOₓ (M=metal)-based negative electrode active material) as a second negative electrode active material, a mixture ratio between the first negative electrode active material and the second negative electrode active material may be 50:50 to 99:1 (weight %) (e.g., 1:1 to 99:1).

The LiMOₓ (M=metal)-based negative electrode active material may be a lithium vanadium oxide.

The Si-based negative electrode active material may be Si, a Si—C composite, SiOₓ (0<x≤2), or a Si-Q alloy (where Q is an element of (e.g., selected from among) a group including (e.g., consisting of) alkaline metal, alkaline earth metal, a Group 13 element, a Group 14 element, a Group 15 element, a Group 16 element, transition metal, a rare-earth element, and/or a (e.g., any suitable) combination thereof, and does not include Si). The Sn-based negative electrode active material may include Sn, SnO₂, and a Sn—R alloy (where R is an element of (e.g., selected from among) a group including (e.g., consisting of) alkaline metal, alkaline earth metal, a Group 13 element, a Group 14 element, a Group 15 element, a Group 16 element, transition metal, a rare earth element, and/or a (e.g., any suitable) combination thereof, and does not include Sn). Further, at least one of these elements may be mixed with SnO₂ and utilized. The element Q and the element R may be at least one element of (e.g., selected from among) a group including (e.g., consisting of) Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and/or a (e.g., any suitable) combination thereof.

A content (e.g., amount) of the negative electrode active material in the negative electrode active material layer may be 95 wt % (i.e., weight %) to 99 wt % based on a total weight (100 wt %) of the negative electrode active material layer.

The negative electrode active material may include a binder and further optionally include a conductive material. A content (e.g., amount) of the binder in the negative electrode active material may be 1 wt % to 5 wt % based on a total weight of the negative electrode active material. In one or more embodiments, in embodiments in which the conductive material is further included, the negative electrode active material may be utilized in the amount of 90 wt % to 98 wt %. The binder may be utilized in the amount of 1 wt % to 5 wt %, and the conductive material may be utilized in the amount of 1 wt % to 5 wt %.

The binder serves to facilitate adhering negative electrode active material particles and facilitate adhering the negative electrode active material to the negative electrode substrate. As the binder, a non-aqueous binder, an aqueous binder, and/or a (e.g., any suitable) combination thereof may be utilized.

Examples of the non-aqueous binder may include polyvinyl chloride, carboxylated polyvinyl chloride, polyvinyl fluoride, a polymer including an ethylene oxide, polyvinyl pyrrolidone, polyurethane, polytetrafluoroethylene, polyvinylidene fluoride, polyethylene, polypropylene, polyamideimide, polyimide, and/or a (e.g., any suitable) combination thereof.

Examples of the aqueous binder may include styrene-butadiene rubber, acrylated styrene-butadiene rubber (SBR), acrylonitrile-butadiene rubber, acryl rubber, butyl rubber, an ethylene-propylene copolymer, polyepichlorohydrin, polyphosphazene, polyacrylonitrile, polystyrene, ethylene propylene diene copolymer, polyvinyl pyridine, chlorosulfonated polyethylene, latex, polyester resin, acryl resin, phenol resin, epoxy resin, polyvinyl alcohol, acrylate-based resin, and/or a (e.g., any suitable) combination thereof.

In case that the aqueous binder is utilized as the negative electrode binder, a cellulose-based compound capable of imparting viscosity may be further contained (included) as a thickener. As the cellulose-based compound, one or more of carboxymethyl cellulose, hydroxypropyl methyl cellulose, methyl cellulose, alkali metal salt thereof, and/or the like may be utilized alone or in combination. Na, K, or Li may be utilized as the alkaline metal. A content (e.g., amount) of the thickener may be 0.1 parts by weight to 3 parts by weight based on 100 parts by weight of the negative electrode active material.

The conductive material is utilized to impart conductivity to the electrode, and any electronically conductive material (e.g., conductor), which does not cause a chemical change in the battery, may be utilized. Examples of the conductive material may include a carbon-based material such as natural graphite, artificial graphite, carbon black, acetylene black, Ketjen black, and/or carbon fiber; metal powder such as copper, nickel, aluminum, and/or silver, and/or a metal-based material such as metal fiber; a conductive polymer such as polyphenylene derivative; and/or a conductive material containing (including) a (e.g., a suitable) mixture thereof.

In one or more embodiments, a BET specific surface area of the negative electrode active material layer may be less than 3.0 m²/g, or may be in a range of 0.6 to 1.2 m²/g. In embodiments in which the BET specific surface area of the negative electrode active material layer is less than 3.0 m²/g, the electrochemical cycle-life characteristic of cells may be improved.

The BET (i.e., Brunauer-Emmett-Teller) measurement was performed by charging/discharging the lithium secondary battery including the negative electrode, dismantling the battery in a completely discharged state, cutting the thus-obtained negative electrode into a set or predetermined size, placing the negative electrode in a BET sample holder, and measuring the negative electrode with a nitrogen gas adsorption method.

The negative electrode may have a single-sided loading level (L/L) of 6 mg/cm² to 65 mg/cm².

The lower layer 7 and the upper layer 8 may be made of the same material. However, the present disclosure is not limited thereto, and the lower layer 7 and the upper layer 8 may be made of different materials. The lower layer 7 may be made of a material having relatively higher conductivity and/or bondability with the substrate than the upper layer 8.

For example, the lower layer may include a carbon-based conductive material. The carbon-based conductive material (e.g., conductors) included in the lower layer 7 may be (e.g., may be selected from among) the carbon-based conductive materials included in the active material layer. The lower layer 7 may include the same carbon-based conductive material as the upper layer 8. As the lower layer 7 includes the carbon-based conductive material, the lower layer 7 may be a conductive layer, for example. For example, the lower layer 7 may be a conductive layer including a binder and a carbon-based conductive material.

The binder included in the lower layer 7 may increase a binding force between the substrate and the upper layer 8. For example, the binder included in the lower layer 7 may be a conductive binder or a non-conductive binder.

For example, the conductive binder may be an ionically conductive binder and/or an electronically conductive binder. The binder having both (e.g., simultaneously) ionic conductivity and electronic conductivity may be both an ionically conductive binder and an electronically conductive binder.

For example, the ionically conductive binder may be made of (e.g., may include) polystyrene sulfonate (PSS), polyvinylidene fluoride-hexafluoropropylene copolymer (PVDF-HFP), polyvinyl fluoride (PVF), polyvinylidene fluoride (PVDF), polymethyl methacrylate (PMMA), polyethylene oxide (PEO), polyethylene glycol (PEG), polyacrylonitrile (PAN), polytetrafluoroethylene (PTFE), polyethylene dioxythiophene (PEDOT), polypyrrole (PPY), polyacrylonitrile (PAN), polyaniline, polyacetylene, and/or the like. The ionically conductive binder may include a polar functional group. For example, the ionically conductive binder including the polar functional group may be Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone) SPAEK, poly[bis(benzimidazobenzisoquinolinones)] (SPBIBI), poly(styrene sulfonate) (PSS), lithium 9,10-diphenylanthracene-2-sulfonate (DPASLi+), and/or the like.

For example, the electronically conductive binder may be polyacetylene, polythiophene, polypyrrole, poly(p-phenylene), poly(phenylenevinylene), poly(phenylenesulfide), polyaniline, and/or the like. For example, an intermediate layer may be a conductive layer including a conductive polymer.

The binder included in the lower layer 7 may be (e.g., may be selected from among) the binders included in the upper layer 8. For example, the lower layer 7 may include the same binder as the upper layer 8. For example, the binder included in the lower layer 7 may be a fluorine-based binder, and the fluorine-based binder may be polyvinylidene fluoride (PVDF), for example.

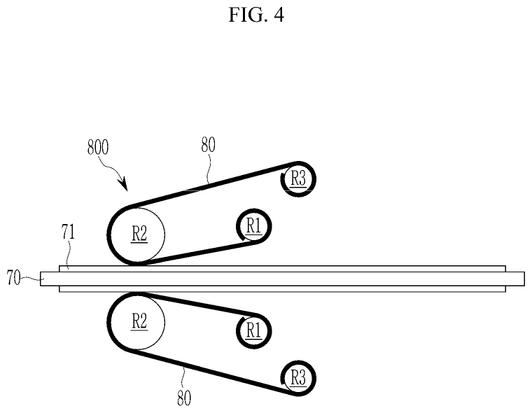

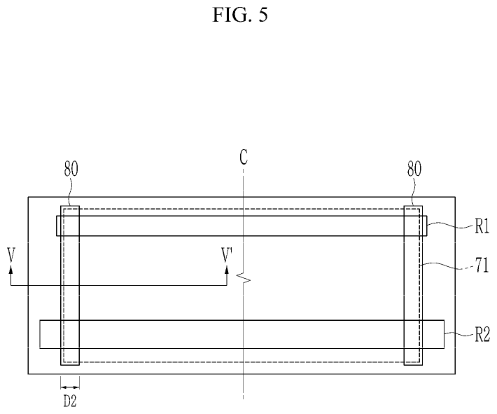

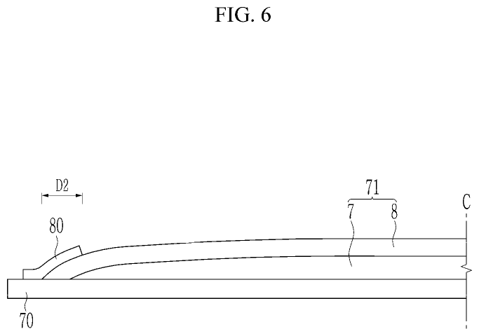

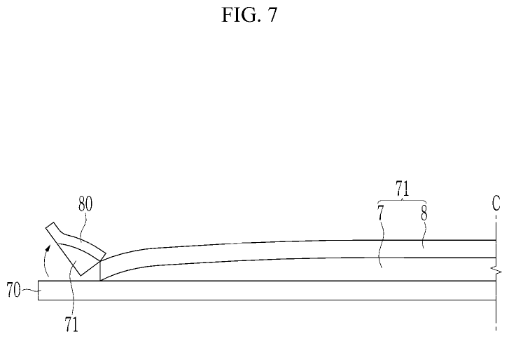

FIG. 4 is a schematic view for explaining a method of manufacturing a negative electrode according to one or more embodiments of the present disclosure, FIG. 5 is a plan (e.g., top plan) view of the negative electrode in an intermediate step (e.g., act or task) of manufacturing the negative electrode according to one or more embodiments of the present disclosure, and FIGS. 6 and 7 are each a schematic cross-sectional view taken along the line V-V′ of FIG. 5 in the intermediate step (e.g., act or task) of manufacturing the negative electrode according to one or more embodiments of the present disclosure. Here, unless otherwise defined, the listing of steps, tasks, or acts in a particular order should not necessarily mean that the present disclosure or claims require that particular order. That is, the general rule that unless the steps, tasks, or acts of a method (e.g., a method claim) actually recite an order, the steps, tasks, or acts should not be construed to require one. Furthermore, any element in a claim that does not explicitly state “means for” performing a specified function, or “step for” performing a specific function, is not to be interpreted as a “means” or “step” clause as specified in 35 U.S.C. § 112(f). In particular, the use of “step of” or “act of” in the claims herein is not intended to invoke the provisions of 35 U.S.C. § 112(f).

As illustrated in FIGS. 4 to 6, the upper layer 8 and the lower layer 7 of the active material layer 71 are formed by applying an active material by an application device 800 onto one surface of the substrate 70 continuously supplied by a roll.

The application device 800 includes a first roll R1 configured to supply a tape 80, a second roll R2 configured to bring a tape 80 into contact with the active material layer, and a third roll R3 configured to retrieve the tape 80 removed from the active material layer.

In one or more embodiments, the upper layer may be formed after the lower layer is formed. However, the present disclosure is not limited thereto, and a double layer may be formed by applying the lower layer and the upper layer. In this case, because the upper layer needs to cover the end of the lower layer, the upper layer may be formed first by applying the active material in the time interval before the lower layer is formed.

Then, the tape 80 may be attached to the edge of the active material layer 71, i.e., the edge of the upper layer 8.

In one or more embodiments, the edge of the upper layer 8 may be a portion where the thickness is not constant and decreases toward the end, such that an inclined surface is formed (see, e.g., FIG. 6). The edge of the upper layer 8 may have a width D2 of about 30 mm or less.

The tape 80 is wound around the first roll R1, and the tape 80 is arranged at the edge of the active material layer 71 as the tape 80 is unwound. The tape 80 may have appropriate or suitable tensile strength as desired or required to attach and remove the tape so that the tape does not break during a process of attaching the tape by utilizing the roll and a process of detaching the tape that will be described in more detail below.

The tape 80 arranged on the active material layer 71 is attached to an upper surface of the active material layer 71 by being pressed by the second roll R2.

The second roll R2 may be made of an elastic material so that the second roll R2 concurrently (e.g., simultaneously) presses the edges of the active material layers 71 having different thicknesses. In one or more embodiments, the pressure applied to the active material layer having a relatively large thickness would be higher than the pressure applied to the active material layer having a smaller thickness, such that the active material layer may be more strongly bonded.

The tape 80 may be removed from the active material layer 71 while being wound around the third roll R3 after being pressed by the second roll R2. In this case, as illustrated in FIG. 7, the edge of the upper layer 8 may be removed together with the tape 80.

The bonding force between the tape 80 and the upper layer 8 may be higher than the bonding force between the upper layer 8 and the substrate 70.

Therefore, the bonding force, which attaches the tape 80 to the upper layer 8, is higher than the bonding force that attaches the upper layer 8 to the substrate 70. Therefore, the upper layer 8 may be easily removed from the substrate together with the tape 80, and the upper layer 8 is also removed as the tape 80 is removed, such that the substrate 70 arranged below the upper layer 8 is exposed.

The process of attaching the tape 80 to the active material layer 71 and removing the tape 80 may be continuously performed, as illustrated in FIG. 4.

Because the process of attaching and removing the tape 80 is performed continuously by utilizing the roll, two opposite surfaces of the tape 80 may have bondability so that the tape 80 may be easily wound without a slip. In one or more embodiments, the bonding force of the other surface of the tape 80, which is opposite to one surface attached to the active material layer, may be lower than the bonding force of one surface attached to the active material layer to a degree to which the tape does not slip on the roll.

In one or more embodiments, only one surface of the tape 80, which is attached to the active material layer, may have the bonding force, and the other surface of the tape 80 may have surface roughness to a degree to which the tape does not slip on the surface of the roll.

For example, the tape 80 may be made of wood as a raw material. The tape 80 may be a kraft tape having one surface having the bonding force, and the other surface having relatively high surface roughness to prevent or reduce slippage. In one or more embodiments, the tape 80 may be made of a material such as PE foam having elasticity, and the tape 80 may be easily pressed and attached even though the active material layers have different thicknesses at the time of attaching the tape by utilizing the roll.

As illustrated in FIG. 7, the cut surface S2 is formed as the edge of the upper layer 8 is removed. Depending on an attachment area of the tape 80, the end of the lower layer 7 may not be exposed through the cut surface S2, as illustrated in FIG. 1, or may be exposed, as illustrated in FIG. 2.

For example, the tape 80 is attached to the edge of the upper layer 8 that does not overlap the lower layer 7. In embodiments in which a boundary line of the tape 80 does not overlap the end of the lower layer 7, the upper layer 8 may have the cut surface in a shape in which the upper layer 8 covers the end of the lower layer 7, as illustrated in FIG. 1.

In one or more embodiments, in embodiments in which the tape 80 overlaps the lower layer 7, a part of the lower layer 7 may also be removed as the upper layer 8 is removed. In embodiments in which the tape 80 is attached so that the boundary of the tape 80 is adjacent to the end of the lower layer 7, the upper layer 8 positioned adjacent to the end of the lower layer 7 is removed, such that the end of the lower layer 7 may be exposed at the cut surface S2, as illustrated in FIG. 2.

In one or more embodiments of the present disclosure, if (e.g., when) the bonding forces of the tape 80, the upper layer 8, and the lower layer 7 and the attachment area of the tape 80 are adjusted, a gradient of the edge of the active material layer 71 may be increased, such that the active material layer 71 with a substantially uniform thickness may be formed in a state in which thickness deviations are decreased at the central portion and the edge of the active material layer 71. Therefore, a phenomenon such as lithium precipitation decreases, such that a stable secondary battery may be provided.

The electrode may be utilized as the negative electrode of the secondary battery and will be described in more detail below with reference to the drawings.

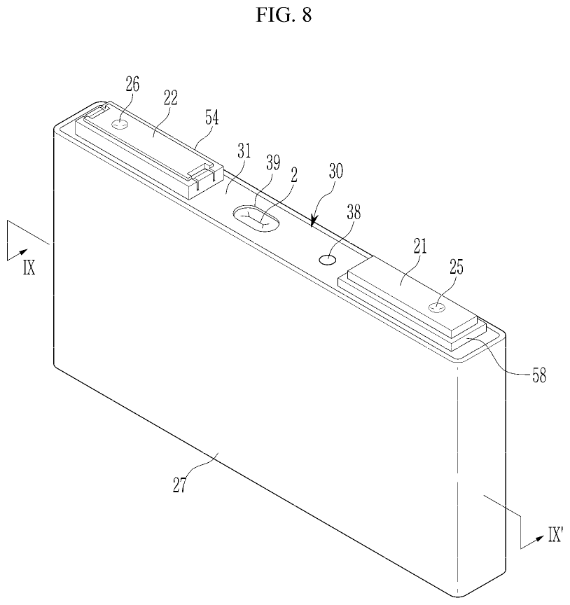

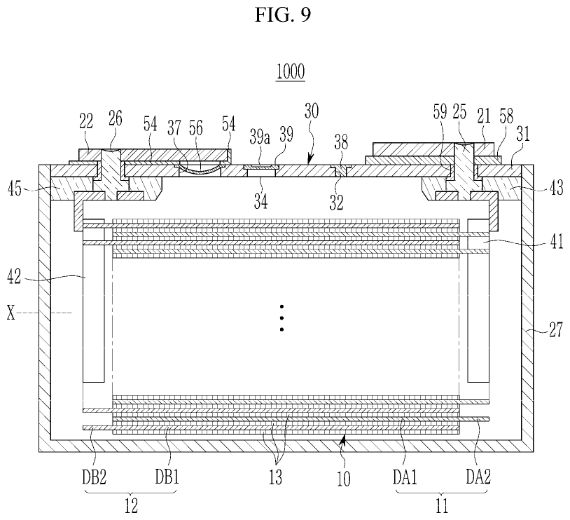

FIG. 8 is a schematic perspective view of a secondary battery according to one or more embodiments of the present disclosure, and FIG. 9 is a schematic cross-sectional view taken along the line IX-IX′ in FIG. 8, according to one or more embodiments of the present disclosure.

As illustrated in FIGS. 8 and 9, a secondary battery 1000 according to one or more embodiments of the present disclosure includes an electrode assembly 10, a casing 27 configured to accommodate the electrode assembly 10, and a cap assembly 30 installed in an opening of the casing 27.

The electrode assembly 101 includes positive electrodes 11, negative electrodes 12, and separators 13 positioned between the positive electrodes 11 and the negative electrodes 12 that are sequentially stacked. The separator 13 is arranged between the positive electrode 11 and the negative electrode 12 and insulates the positive electrode 11 and the negative electrode 12.

The electrode assembly 10 may be a jelly roll type or kind by interposing the separator 13 between the positive electrode (or first electrode) 11 and the negative electrode (or second electrode) 12, winding the electrode assembly 10 about a winding axis X, and pressing the electrode assembly 10 flat.

The positive electrode 11 includes a substrate, an electrode active portion DA1 having the active material layer, and an electrode non-coated portion DA2 in which the active material layer is not formed so that the substrate is exposed. The substrate may be made of aluminum. As the active material of the positive electrode 11, a compound capable of reversible intercalation and deintercalation of lithium (a lithiated intercalation compound) may be utilized. For example, one or more of composite oxides of lithium and metal of (e.g., selected from among) cobalt, manganese, nickel, and/or a (e.g., any suitable) combination thereof may be utilized. A content (e.g., amount) of the positive electrode active material may be 90 wt % to 98 wt % based on a total weight of the positive electrode active material layer.

The positive electrode active material layer may further include a binder and a conductive material. In one or more embodiments, a content (e.g., amount) of the binder and the conductive material may be 1 wt % to 5 wt % based on a total weight (100 wt %) of the positive electrode active material layer.

The binder serves to facilitate adhering the positive electrode active material particles and facilitate adhering the positive electrode active material to the substrate that is a current collector. Representative examples of the binders may include polyvinyl alcohol, carboxymethyl cellulose, hydroxypropyl cellulose, diacetyl cellulose, diacetyl cellulose, polyvinyl chloride, carboxylated polyvinyl chloride, polyvinyl fluoride, a polymer containing an ethylene oxide, polyvinyl pyrrolidone, polyurethane, polytetrafluoroethylene, polyvinylidene fluoride, polyethylene, polypropylene, styrene butadiene rubber, acrylated styrene butadiene rubber, epoxy resin, nylon, and/or the like, but the present disclosure is not limited thereto. The conductive material is utilized to impart conductivity to the electrode, and any electronically conductive material (e.g., conductor), which does not cause a chemical change in the battery, may be utilized.

The negative electrode 12 includes a substrate, an electrode active portion DB1 including the active material layer, and an electrode non-coated portion DB2 in which the active material layer is not formed so that the substrate is exposed. The negative electrode may be the negative electrode illustrated in FIG. 1, 2 or 3. The active material layer of the electrode active portion may be formed as an active material layer including lower and upper layers formed on at least one surface of the substrate. An edge of the lower layer may have an inclined surface, an upper layer may cover the inclined surface, and an end of the active material layer may have a vertical cut surface.

The separator 13 is a polymer film that transmits lithium ions. As the separator 13, polyethylene, polypropylene, polyvinylidene fluoride, or a multilayer of two or more thereof may be utilized, or a mixed multilayer such as a two-layer separator of polyethylene/polypropylene, a three-layer separator of polyethylene/polypropylene/polyethylene, a three-layer separator of polypropylene/polyethylene/polypropylene, and/or the like may be utilized.

In one or more embodiments, the electrode assembly 10 may be accommodated in the casing 27 together with an electrolyte, and the electrolyte may include a non-aqueous organic solvent and lithium salt.

The non-aqueous organic solvent serves as a medium through which ions involved in the electrochemical reaction of the battery may move.

The lithium salt is dissolved in an organic solvent to act as a source of lithium ions in the battery to enable operation of a basic lithium secondary battery and to promote movements of lithium ions between the positive electrode and the negative electrode. Representative examples of the lithium salt include one or more supporting electrolyte salts of (e.g., selected from among) a group including (e.g., consisting of) LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂, C_{y}F_{2y+1}SO₂) (wherein x and y are natural numbers, e.g., 1 to 20), LiCl, LiI, and/or LiB(C₂O₄)₂ (lithium bis(oxalato) borate: LiBOB). A concentration of the lithium salt may be within a range of about 0.1 M to about 2.0 M. When the concentration of the lithium salt is within the above range, the electrolyte may have appropriate or suitable conductivity and viscosity, thereby exhibiting excellent or suitable electrolyte performance and allowing lithium ions to effectively move.

The casing 27 may be made of metal such as aluminum and have an approximately rectangular parallelepiped shape. One side of the casing 27 may be opened, and a cap plate 31 may be installed at one opened side of the casing 27.

The cap assembly 30 includes a cap plate 31 coupled to the casing 27 and configured to block or close the opening of the casing 27, a positive electrode terminal 21 protruding outward from the cap plate 31 and electrically connected to the positive electrode 11, and a negative electrode terminal 22 electrically connected to the negative electrode 12.

The cap plate 31 is provided in the form of an elongated plate extending in one direction and coupled to the opening of the casing 27.

The cap plate 31 has an injection port 32 configured to communicate with the inside of the casing 27. The injection port 32 is utilized to inject the electrolyte, and a sealing closure 38 is installed in the injection port 32. In one or more embodiments, in the cap plate 31, a vent plate 39 having a notch 39a is installed in a vent hole 34 so that the vent hole 34 is opened at a preset pressure.

The positive electrode terminal 21 and the negative electrode terminal 22 are installed to protrude upward from the cap plate 31. The positive electrode terminal 21 is electrically connected to the positive electrode 11 by (via) a current collecting tab 41, and the negative electrode terminal 22 is electrically connected to the negative electrode 12 by (via) a current collecting tab 42.

A terminal connection member 25, which electrically connects the positive electrode terminal 21 and the current collecting tab 41, is installed between the positive electrode terminal 21 and the current collecting tab 41. The terminal connection member 25 is inserted into a hole formed in the positive electrode terminal 21, an upper end of the terminal connection member 25 is fixed to the positive electrode terminal 21 by welding, and a lower end of the terminal connection member 25 is fixed to the current collecting tab 41 by welding.

A gasket 59 is installed between the terminal connection member 25 and the cap plate 31 and inserted into a hole penetrated by the terminal connection member 25 to seal the terminal connection member 25 and the cap plate 31. A lower insulation member 43 is installed below the cap plate 31, and a lower portion of the terminal connection member 25 is inserted into the lower insulation member 43. A connection plate 58 is installed to electrically connect the positive electrode terminal 21 and the cap plate 31. The terminal connection member 25 is installed by being fitted with the connection plate 58. Therefore, the cap plate 31 and the casing 27 are electrified as the positive electrode 11.

A terminal connection member 26, which electrically connects the negative electrode terminal 22 and the current collecting tab 42, is installed between the negative electrode terminal 22 and the current collecting tab 42. The terminal connection member 26 is inserted into a hole formed in the negative electrode terminal 22, an upper end of the terminal connection member 26 is fixed to the negative electrode terminal 22 by welding, and a lower end of the terminal connection member 26 is fixed to the current collecting tab 42 by welding.

The gasket 59 is installed between the negative electrode terminal 22 and the cap plate 31 and inserted into a hole penetrated by the terminal connection member 26 to seal the negative electrode terminal 22 and the cap plate 31, and an upper insulation member 54 is installed to insulate the negative electrode terminal 22 and the cap plate 31. The terminal connection member 26 may be installed by being fitted within a hole of the upper insulation member 54. The upper insulation member 54 may be formed to be around (e.g., surround) the end of the negative electrode terminal 22.

Further, the lower insulation member 45 is installed below the cap plate 31 and insulates the negative electrode terminal 22 and the current collecting tab 42 from the cap plate 31.

A short circuit hole 37 is formed in the cap plate 31, and a short circuit member 56 is installed in the short circuit hole 37. The short circuit member 56 includes a curved portion curved convexly downward in an arc shape, and a rim portion formed at an outer side of the curved portion and fixed to the cap plate 31. The upper insulation member 54 may have a cut-out portion that overlaps the short circuit hole 37, and the short circuit member 56 overlaps the negative electrode terminal 22 exposed through the cut-out portion.

The short circuit member 56 is electrically connected to the cap plate 31. When the internal pressure of the secondary battery 1000 increases, the short circuit member 56 is deformed and causes a short circuit of the positive and negative electrodes. For example, if (e.g., when) a gas is produced because of an abnormal reaction in the secondary battery, the internal pressure of the secondary battery increases. When the internal pressure of the secondary battery is higher than a preset pressure, the curved portion is deformed to be convexly upward. In such cases, the negative electrode terminal 22 and the short circuit member 56 come into contact with each other, which causes a short circuit.

In order to easily implement a short circuit of the negative electrode terminal 22 and the short circuit member 56, the negative electrode terminal 22 may further include at least one protrusion protruding toward the short circuit member 56, and the protrusion may be spaced and/or apart (e.g., spaced apart or separated) from the short circuit member 56.

The above-mentioned embodiments of the secondary battery including the angular casing have been described. However, the present disclosure is not limited thereto, and the secondary battery may include a cylindrical casing and a pouch-type or kind casing.

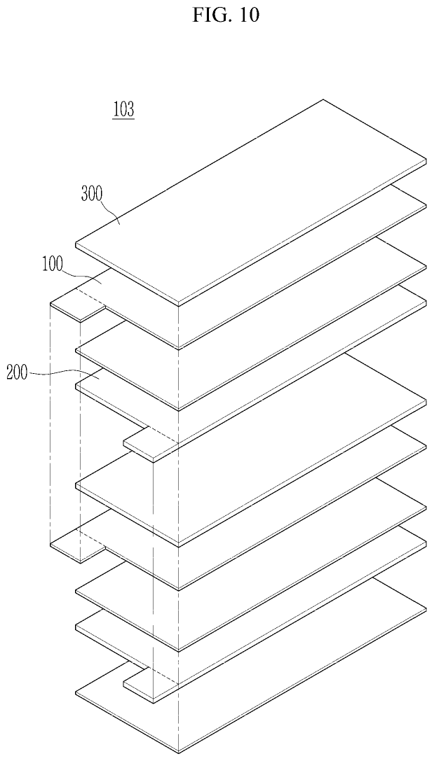

In addition, the above-mentioned embodiments of the winding-type or kind electrode assembly have been described. However, the present disclosure is not limited thereto, and the present disclosure may be applied to a stacked structure, as illustrated in FIG. 10.

FIG. 10 is a schematic exploded perspective view of an electrode assembly according to one or more embodiments of the present disclosure.

Because the electrode assembly in FIG. 10 is mostly substantially identical to the electrode assembly in FIG. 1, only differences may be described.

With reference to FIG. 10, an electrode assembly 103 according to one or more embodiments of the present disclosure may be a sheet-type or kind electrode assembly in which first electrodes 100, separators 300, second electrodes 200, and separators 300 are alternately stacked, and the first electrode 100, the separator 300, the second electrode 200, and the separator 300 are independently stacked.

The first and second electrodes 100 and 200 each include an electrode active portion having an active material layer, and an electrode non-coated portion in which the active material layer is not formed so that a substrate is exposed. The electrode non-coated portion may have a shape protruding from the electrode active portion in one direction.

As illustrated in FIGS. 1 to 3, the active material layer of the electrode active portion may include a lower layer having an inclined surface, and an upper layer formed on the lower layer. As illustrated in FIGS. 4 to 7, an edge of the active material layer may be formed by utilizing the tape.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Further, the use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within +30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The portable device, vehicle, and/or the battery, e.g., a battery controller, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

What is claimed is:

1. An electrode comprising:
a substrate;
an active material layer comprising a lower layer on the substrate, and an upper layer on the lower layer,
wherein an edge of the lower layer has an inclined surface having a thickness that decreases toward an end of the lower layer,
wherein the upper layer has a cut surface on the inclined surface and at an end of the upper layer, and an angle defined between the cut surface and an upper surface of the substrate is larger than an angle defined between the inclined surface and the upper surface of the substrate, and
wherein the electrode is for a secondary battery.

2. The electrode of claim 1, wherein a bonding force between the upper layer and the lower layer is lower than a bonding force between the lower layer and the substrate.

3. The electrode of claim 1, wherein:
the substrate further comprises a concave groove in a surface of the substrate, and
wherein the end of the lower layer is in the groove, and the groove is filled with the lower layer.

4. The electrode of claim 3, wherein:
a depth of the groove is about 1 micrometer (μm) to about 5 μm, and
a width of the groove is about 1 millimeter (mm) to about 10 mm.

5. The electrode of claim 1, wherein the upper layer covers the edge of the lower layer, such that the end of the lower layer is not exposed at the cut surface.

6. The electrode of claim 1, wherein the end of the upper layer and the end of the lower layer are exposed at the cut surface.

7. The electrode of claim 1, wherein a length of the inclined surface of the lower layer is about 30 mm from the end of the lower layer.

8. A method of manufacturing an electrode for a secondary battery, the method comprising:
applying a lower layer onto a substrate;
forming an upper layer to cover an edge of the lower layer on the lower layer;
attaching a tape onto an edge of the upper layer; and
removing the edge of the upper layer together with the tape.

9. The method of claim 8, wherein the tape is attached at the edge of the upper layer at a position outward of the lower layer.

10. The method of claim 8, wherein a width of the edge of the upper layer is about 30 mm or less.

11. The method of claim 8, wherein a bonding force between the tape and the upper layer is higher than a bonding force between the upper layer and the substrate, lower than a bonding force between the lower layer and the substrate, and lower than a bonding force between the upper layer and the lower layer.

12. The method of claim 8, wherein the attaching of the tape comprises bringing the tape into close contact with an upper surface of the upper layer by pressing the tape.

13. The method of claim 8, wherein the tape is a kraft tape or polyethylene (PE) foam.
